(19) United States
(12) Patent Application Publication
(10) Pub. No.: US 2026/0289621 A1
(43) Pub. Date: Sep. 24, 2026

(54) CERTIFICATION AND TRANSACTION METHOD AND APPARATUS FOR ELECTRONIC CIGARETTE, DEVICE, AND STORAGE MEDIUM

(71) Applicant: SHENZHEN FUNYIN ELECTRONIC TECHNOLOGY CO.,LTD, Shenzhen (CN)

(72) Inventors: Ying ZHOU, Shenzhen (CN); Jinfang ZHANG, Shenzhen (CN)

(73) Assignee: SHENZHEN FUNYIN ELECTRONIC TECHNOLOGY CO.,LTD, Shenzhen (CN)

(21) Appl. No.: 19/326,619

(22) Filed: Sep. 11, 2025

(30) Foreign Application Priority Data
Mar. 18, 2025 (CN) 202510320518.1

(51) Int. Cl. G06Q 30/0601; G06Q 20/38; G06Q 20/40; G06Q 30/018; G06V 40/16

(52) U.S. Cl. CPC G06Q 30/0607; G06Q 20/3827; G06Q 20/40145; G06Q 30/0185; G06V 40/178

(57) ABSTRACT

A certification and transaction method for an electronic cigarette includes: in response to sending an order initiation instruction to a target device, creating an order to be verified based on a buyer virtual number through a third-party certification node; verifying device purchase eligibility of the buyer virtual number in the order to be verified through the third-party certification node, and obtaining an associated preset seller virtual number; and in response to successful verification of the purchase eligibility, generating an activation instruction ciphertext containing a device serial number, executing an activation operation of the target device based on the activation instruction ciphertext, and storing a transaction information record containing the buyer virtual number and the seller virtual number.

### CROSS-REFERENCE TO RELATED APPLICATIONS

This application claims priority to Chinese Patent Application No. 202510320518.1, filed on Mar. 18, 2025, the content of which is incorporated herein by reference in its entirety.

### TECHNICAL FIELD

The present application relates to the technical field of electronic cigarette certification, in particular to a certification and transaction method and apparatus for an electronic cigarette, a device, and a storage medium.

### BACKGROUND

With the continuous advancement of electronic cigarette technology and the rapid growth of market sales, this type of product is being favored by an increasing number of consumers due to its unique design and e-liquid heating technology. However, these characteristics of electronic cigarettes also pose regulatory challenges. Especially among the adolescent group, the covert purchasing channels and camouflage tactics of electronic cigarettes enable many underage users to easily obtain and use these products, posing a threat to their physical and mental health. This clearly demonstrates the limitations of existing sales management modes for electronic cigarettes.

First, retailers may ignore age restrictions during sales. They may directly sell electronic cigarettes to minors driven by profit motives. Or due to loopholes in an existing system and weak enforcement, the minors can easily obtain electronic cigarettes by various means. Meanwhile, consumers may also choose to ignore relevant laws and regulations due to neglecting or misunderstanding age restriction labels, resulting in a further expansion of regulatory loopholes. Existing management measures fail to effectively address these problems, thereby increasing the potential health risks of electronic cigarettes for adolescents.

Secondly, strengthening the regulation of electronic cigarettes is not only an important means to protect the health of minors but also involves raising public awareness of their hazards. However, a real-name system in regulatory measures may also lead to issues such as identity information leakage and misuse, further infringing upon the legitimate rights and interests of both consumers and merchants.

Therefore, striking a balance between protecting the health of minors and safeguarding commercial interests has become an important issue in current regulation of electronic cigarettes.

### SUMMARY

To overcome the deficiencies in the prior art, the present application provides a certification and transaction method and apparatus for an electronic cigarette, a device, and a storage medium, which aim to ensure that only users who have reached the legal age can legally purchase electronic cigarettes by verifying identity information of buyers and sellers as well as their purchase and sale eligibility in real time, thus effectively preventing minors from getting involved in the electronic cigarette market, and reducing the relevant health and safety risks caused by the use of the electronic cigarettes by the minors.

A technical solution adopted by the present application to solve the technical problem is as follows.

In a first aspect, the present application provides a certification and transaction method for an electronic cigarette, including:

in response to sending an order initiation instruction to a target device, creating an order to be verified based on a buyer virtual number through a third-party certification node, where the buyer virtual number is bound to buyer identity information in an irreversible mapping manner and is only stored in the third-party certification node;

verifying device purchase eligibility of the buyer virtual number in the order to be verified through the third-party certification node, and obtaining an associated preset seller virtual number, where the seller virtual number is bound to seller identity information in an irreversible mapping manner and is only stored in the third-party certification node; and

in response to successful dual verification of the purchase eligibility and sale eligibility, generating an activation instruction ciphertext containing a device serial number, executing an activation operation of the target device based on the activation instruction ciphertext, and storing a transaction information record containing the buyer virtual number and the seller virtual number.

Optionally, after the step of obtaining an associated preset seller virtual number, the method further includes:

verifying whether a validity period of the seller virtual number exceeds a preset time limit threshold by accessing a registration timestamp in the third-party certification node;

in response to the validity period of the seller virtual number exceeding the preset time limit threshold, parsing at least one piece of certification field data in an electronic registration document of a corresponding seller;

comparing the certification field data with a corresponding field recorded by the third-party certification node item by item, and when there is a numerical difference, generating a high-risk identification code; and

triggering a manual review based on the high-risk identification code, and transmitting a manual review request containing a comparison result of discrepancy fields to a regulatory node.

Optionally, the step of storing a transaction information record containing the buyer virtual number and the seller virtual number includes:

in response to the activation operation of the target device, correspondingly generating the transaction information record of the target device, and writing the transaction information record into a blockchain evidence preservation system through the third-party certification node; and

in response to an information traceability instruction sent by a regulatory node, obtaining the corresponding buyer identity information and seller identity information based on the buyer virtual number and the seller virtual number associated with the transaction information record written in the blockchain evidence preservation system.

Optionally, after the step of executing an activation operation of the target device based on the activation instruction ciphertext, the method further includes:

in response to a device initialization instruction, acquiring biometric data of a current user;

inputting the biometric data to a pre-trained deep age estimation model, and parsing the biometric data by the deep age estimation model to output an estimated age value of the current user and a corresponding confidence level parameter;

if the estimated age value exceeds a preset age threshold and the corresponding confidence level parameter exceeds a preset confidence level threshold, encrypting and storing the biometric data as a device startup credential; and

if the estimated age value does not exceed the preset age threshold, retrieving identity credential information corresponding to the current user from the third-party certification node for appeal verification, and when and only when the appeal verification is passed, encrypting and storing the biometric data as the device startup credential.

Optionally, the biometric data is multi-modal feature information, the multi-modal feature information including at least two pieces of biometric feature information of the current user; and

the step of inputting the biometric data to a pre-trained deep age estimation model, and parsing the biometric data by the deep age estimation model to output an estimated age value of the current user and a corresponding confidence level parameter includes:

performing spatiotemporal synchronization calibration on the multi-modal feature information, so that an acquisition time interval between every two pieces of biometric feature information in the multi-modal feature information does not exceed a preset time threshold;

inputting the multi-modal feature information subjected to the spatiotemporal synchronization calibration to the deep age estimation model, and performing joint encoding on each piece of biometric feature information in the multi-modal feature information through the deep age estimation model to generate a composite feature vector; and

executing age prediction and confidence level estimation in parallel by the deep age estimation model based on the composite feature vector to output the estimated age value and the corresponding confidence level parameter.

Optionally, before the step of inputting the biometric data to a pre-trained deep age estimation model, the method further includes:

analyzing matching degrees between the biometric data and pre-stored buyer biometric feature templates, where the pre-stored buyer biometric feature templates are constructed based on the buyer identity information; and

when the similarity exceeds a preset similarity threshold, activating the target device, and encrypting and storing the biometric data as the device startup credential.

Optionally, after the step of encrypting and storing the biometric data as a device startup credential, the method further includes:

in response to a device startup instruction, acquiring at least one type of biometric data to be verified from the current user, and calculating matching degrees between the biometric data to be verified and all the biometric data in the device startup credential;

if the matching degree between the biometric data to be verified and any biometric data in the device startup credential exceeds a preset matching degree threshold, controlling the target device to enter an unlocked state;

in response to a cartridge disengagement operation, controlling the target device to enter a temporarily locked state;

when a replacement cartridge is inserted, reading encrypted identification data embedded in the replacement cartridge, where the encrypted identification data includes at least a unique identification code and a dynamic hash value;

sending the encrypted identification data to an anti-counterfeiting verification node to verify the validity of the replacement cartridge; and

if the unique identification code is valid, the dynamic hash value matches, and it is confirmed that the target device passes the cartridge verification, controlling the target device to release the temporarily locked state and re-enter the unlocked state;

otherwise, confirming that the target device fails in the cartridge verification, and adjusting the temporarily locked state to a locked state.

In a second aspect, the present application provides a certification and transaction apparatus for an electronic cigarette, including:

an order generation module, configured to create, in response to sending an order initiation instruction to a target device, an order to be verified based on a buyer virtual number through a third-party certification node, where the buyer virtual number is bound to buyer identity information in an irreversible mapping manner and is only stored in the third-party certification node;

an order verification module, configured to verify device purchase eligibility of the buyer virtual number in the order to be verified through the third-party certification node, and obtain an associated preset seller virtual number, where the seller virtual number is bound to seller identity information in an irreversible mapping manner and is only stored in the third-party certification node; and

an information storage module, configured to generate, in response to successful verification of the purchase eligibility, an activation instruction ciphertext containing a device serial number, execute an activation operation of the target device based on the activation instruction ciphertext, and store a transaction information record containing the buyer virtual number and the seller virtual number.

In a third aspect, the present application provides an electronic device, including:

one or more processors;

one or more memories; and

one or more computer programs, where the one or more computer programs are stored in the one or more memories and include instructions, and when the instructions are executed by the one or more processors, the electronic device is caused to execute the above method.

In a fourth aspect, the present application provides a computer-readable storage medium, where a program or an instruction is stored in the storage medium, and when the program or the instruction is executed, the above method is implemented.

In summary, the present application has at least one of the following advantages.

Firstly, When a buyer initiates an order to purchase an electronic cigarette through a target device, a third-party certification node creates an order to be verified based on a buyer virtual number (the virtual number is bound to buyer identity information in an irreversible mapping manner and is only stored in the certification node), and synchronously obtains a seller virtual number (the virtual number is bound to seller identity information in an irreversible mapping manner and is only stored in the certification node). If purchase eligibility of the buyer passes verification, the certification node generates an activation instruction ciphertext containing a serial number of the target device and activates the target device accordingly to complete a transaction process, and stores information related to this transaction process. When traceability is required, only a relevant regulatory node can retrieve the seller identity information corresponding to the seller virtual number and/or the buyer identity information corresponding to the buyer virtual number in this transaction, so as to ensure the security and legality of transactions, prevent minors from purchasing electronic cigarettes with false identity information, effectively avoid loopholes in an existing regulatory system, protect the privacy of both buyers and sellers, and meet the legal and regulatory requirements of commercial operations.

Secondly, after a user performs an activation operation, the system receives a device initialization instruction and then acquires biometric data of the current user, such as fingerprint or facial information. Subsequently, the biometric data is input to a pre-trained deep age estimation model for parsing, and the model outputs an estimated age value of the current user and a confidence level parameter. If the estimated age value exceeds a preset age threshold and the confidence level parameter exceeds a preset threshold, the biometric data is encrypted and stored as a device startup credential. In contrast, if the estimated age value does not exceed the preset age threshold, the system retrieves identity credential information of the user from the third-party certification node for appeal verification, and only when the appeal verification succeeds, the biometric data is encrypted and stored as the device startup credential. Through these steps, this method can effectively confirm whether the user meets the age requirement for using the electronic cigarette and ensure that only users with verified identities can use the device normally.

Lastly, after the electronic cigarette is activated and enters an unlocked state, once it is detected that a cartridge is disengaged, the device automatically enters a temporarily locked state to prevent the replacement of an unauthorized cartridge. When the user tries to replace the original cartridge with a new one, the system reads encrypted identification data embedded in the cartridge, including a unique identification code and a dynamic hash value. The data is sent to an anti-counterfeiting verification node for verification, and a platform verifies the validity of the identification code and whether the dynamic hash value matches. Once the verification succeeds, the electronic cigarette is released from the temporarily locked state and returns to the unlocked state to continue normal operation. If the verification fails, the temporarily locked state is maintained. This mechanism ensures the safety and usage environment of the electronic cigarette and prevents the sale and use of unauthorized products.

### BRIEF DESCRIPTION OF THE DRAWINGS

FIG. 1 is a schematic flowchart of a certification and transaction method for an electronic cigarette provided in an embodiment of the present application.

FIG. 2 is a schematic diagram of a virtual structure of a certification and transaction apparatus for an electronic cigarette provided in the present application.

FIG. 3 is a schematic structural diagram of an electronic device provided in an embodiment of the present application.

### DETAILED DESCRIPTION OF THE EMBODIMENTS

The present application is further described below in conjunction with the accompanying drawings and embodiments.

The following will provide a clear and complete description of the concept, specific structure, and technical effects of the present application in conjunction with the embodiments and accompanying drawings to fully understand the objective, features and effects of the present application. Apparently, the described embodiments are merely some rather than all of the embodiments of the present application, and all other embodiments obtained by those skilled in the art based on the embodiments of the present application without creative efforts fall within the scope of protection of the present application. In addition, all the coupling/connection relationships referred to in the patent do not only mean that the components are directly connected, but also mean that a better coupling structure can be formed by adding or reducing coupling accessories according to specific implementation situations. The various technical features in the present application can be interactively combined without conflicting with each other.

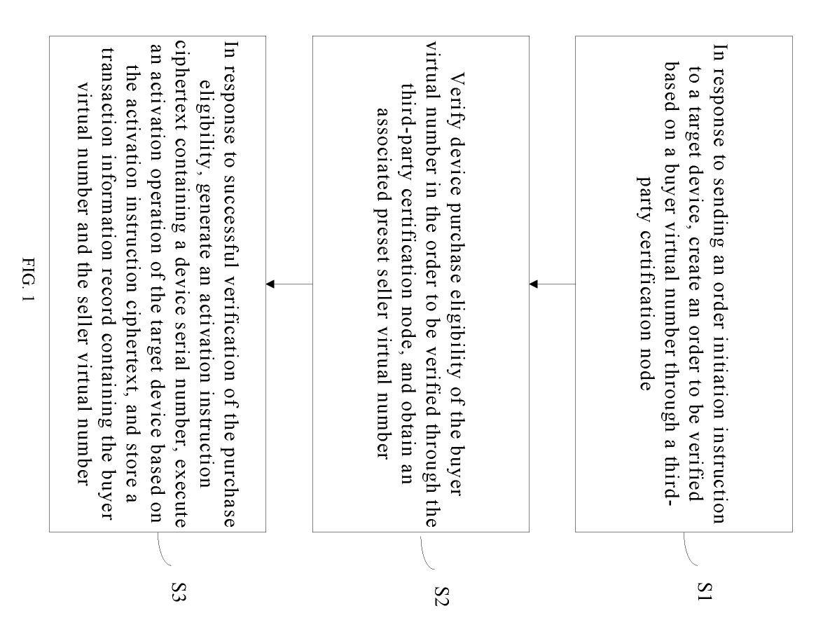

Reference is made to FIG. 1. FIG. 1 is a schematic flowchart of a certification and transaction method for an electronic cigarette provided in an embodiment of the present application. The method specifically includes the following steps, which are separately described in detail below.

In step S1, in response to sending an order initiation instruction to a target device, an order to be verified is created based on a buyer virtual number through a third-party certification node.

The buyer virtual number is bound to buyer identity information in an irreversible mapping manner and is only stored in the third-party certification node.

Specifically, the target device refers to a transaction item in this transaction order, namely an electronic cigarette product that a buyer intends to purchase. The buyer identity information includes, but is not limited to, a buyer identity card, personal information, acquired image information, fingerprint feature information, etc. The order to be verified refers to an order whose validity for this transaction needs to be verified. In this case, the order has not been finally confirmed yet because further identity verification and other necessary checks are still required.

More specifically, when a consumer is ready to purchase an electronic cigarette device, a system sends a transaction initiation instruction to the electronic cigarette device (i.e., the transaction item itself). Upon receiving the instruction, the system completes the following operations through an independent third-party certification center. Specifically, the system automatically converts real information (including an identity card number, a fingerprint, etc.) of the consumer into a unique virtual code. This conversion process employs special encryption technology to ensure that a real identity of the consumer cannot be inferred from the buyer virtual number. For example, a real name is transformed into a random combination of letters and numbers. This conversion is one-way and irreversible. Subsequently, a temporary order to be verified is generated using the above buyer virtual number. This order includes basic information such as a serial number of the electronic cigarette device and purchase time, but any real identity data of the consumer is not recorded. In this case, the order is in an "unconfirmed" state and needs to wait for subsequent eligibility verification.

More specifically, a correspondence between the real information and the virtual code of the consumer is only encrypted and stored in a dedicated server of the third-party certification node. This server adopts an isolated design, so that an external system cannot access it directly, and only a relevant regulatory node and the third-party certification node itself can obtain privacy information.

In step S2, device purchase eligibility of the buyer virtual number in the order to be verified is verified through the third-party certification node, and an associated preset seller virtual number is obtained.

The seller virtual number is bound to seller identity information in an irreversible mapping manner and is only stored in the third-party certification node.

Specifically, in the third-party certification node, a seller account pre-stores the seller identity information prior to listing items for sale.. When the order to be verified is generated, the seller virtual number corresponding to the target object (i.e., the target device intended for purchase) is retrieved by the third-party certification node. Depending on different regional policies or privacy requirements, it is also possible to only obtain the seller virtual number for subsequent storage in a transaction information record. Only when the regulatory node with relevant authority needs to trace the identity information in this transaction information record, the unique bound seller identity information can be found based on the seller virtual number, so as to determine an identity of a seller. When relevant traceability is not required, the identity information is only stored as traceability index information, and the seller identity information corresponding to the seller virtual number cannot be obtained by other nodes without relevant authority. If there is a need to verify sale eligibility of the seller, when verifying whether the buyer identity information indicates that the buyer is an adult, the third-party certification node can also determine whether the seller virtual number is eligible to sell the electronic cigarette device based on the seller virtual number.

More specifically, when the system processes the order to be verified, the purchase eligibility of the buyer is verified, where the purchase eligibility of the buyer is determined by the buyer identity information corresponding to the buyer virtual number. This process is performed by the third-party certification node for verification. The verification for the eligibility of the buyer (i.e., the purchase eligibility of the buyer) mainly confirms the legality of the identity and whether the legal purchase conditions are met. For example, an identity certification system is used to verify whether the age meets the legal requirements, and determine whether there is an abnormal purchase behavior in combination with a historical transaction record. If there is no need to verify the sale eligibility of the seller, the corresponding buyer identity information of the buyer virtual number is retrieved from the third-party certification node, and it is determined whether the buyer meets the preset conditions based on the buyer identity information to determine whether the order to be verified is legal and valid.

If there is a need to verify the sale eligibility of the seller, corresponding verification for the eligibility of the seller (i.e., the sale eligibility of the seller) is added to examine the legality of business qualifications. This includes checking a valid status of an electronic cigarette sales license, the compliance of a licensed business scope, and whether there is a regulatory penalty record. The two verifications are triggered based on the same order data. The correlation and data consistency of the verification process are ensured by sharing an order identifier. During verification, the buyer identity information and seller qualification information are submitted to corresponding verification systems respectively. The system adopts a parallel computing architecture to process two types of requests synchronously. The order is determined as legal and valid only when the eligibility of both the buyer and the seller meets the preset conditions. In this case, this mechanism takes into account the verification of both the buyer and the seller. By eliminating a waiting interval of conventional serial verification, the efficiency of transaction verification is significantly improved, and the dual compliance of the qualifications of both the buyer and the seller is guaranteed.

Further, in the dual verification for the eligibility of the buyer and the seller, in addition to determining the purchase eligibility of the buyer through a valid identity card number and a relevant biometric credential, measures should also be taken to prevent sellers from selling to non-compliant buyers. In this embodiment of the present application, it is proposed that there may be cases where some sellers fraudulently use their sale eligibility. On such basis, it is further proposed in the present application that after the step of obtaining an associated preset seller virtual number, the method further includes:

verifying whether a validity period of the seller identity information exceeds a preset time limit threshold by accessing a registration timestamp in the third-party certification node.

Specifically, the system obtains the registration timestamp of the seller in a business registration system by calling an API interface provided by the authoritative third-party certification node such as a government regulatory platform, and a time difference between the timestamp and the current system time is calculated to verify whether the registration validity period in the seller identity information exceeds the preset time limit threshold (i.e., a legal business duration, such as two years).

Further, in response to the validity period of the seller virtual number exceeding the preset time limit threshold, at least one piece of certification field data in an electronic registration document of a corresponding seller is parsed.

Specifically, when it is identified that the registration validity period exceeds the preset legal business duration (such as two years), key certification fields are automatically extracted from the electronic registration document of the seller, including but not limited to one or more certification fields in a unified social credit code, a licensed business category, and legal representative information.

Further, the certification field data is compared with a corresponding field recorded by the third-party certification node item by item, and when there is a numerical difference, a high-risk identification code is generated.

Specifically, during verification, the system precisely matches the unified social credit code extracted from the electronic document with a filing record in a State Administration for Market Regulation database, and compares inclusion relationships between types of commodities for sale and licensed business categories. If the system detects a mismatch in code check digits or that commodity categories exceed the licensed scope, it generates the high-risk identification code containing details of the difference. In this case, there may be situations of expired certificates or forged credentials. An encoding rule is "Institution Type (1 digit) + Discrepancy Field (2 digits) + Severity Level (1 digit)". For example, "A03B" indicates "Electronic Cigarette Retailer - Licensed Category Mismatch - Level 2 Risk".

Further, a manual review is triggered based on the high-risk identification code, and a manual review request containing a comparison result of discrepancy fields is transmitted to a regulatory node.

Specifically, after the order is tagged with the high-risk identification code, a manual review mechanism is triggered. The system automatically generates a structured review report, highlighting conflicting fields and their comparison results. This report is transmitted to a regulatory authority terminal through an encrypted channel. In a display interface, discrepant data is highlighted in red, accompanied by a side-by-side comparison view of original document screenshots and database record screenshots. Regulatory personnel can make a final judgment on the validity of the business qualifications based on a visual difference analysis in combination with a supplementary material submission function.

More specifically, through the seller qualification verification and the three-tier progressive verification of time limit threshold determination, field-level data verification, and risk code generation, closed-loop management of seller qualifications from formal examination to substantive examination is achieved, and illegal business practices such as expired licenses, counterfeit credentials, and operations beyond the licensed scope are effectively intercepted.

In step S3, in response to successful verification of the purchase eligibility, an activation instruction ciphertext containing a device serial number is generated, an activation operation of the target device is executed based on the activation instruction ciphertext, and a transaction information record containing the buyer virtual number and the seller virtual number is stored.

The activation instruction ciphertext is transmitted to the target electronic cigarette device through a dedicated channel of the third-party certification node to trigger its hardware enablement.

Specifically, after the third-party certification node confirms that the buyer has legal purchase eligibility, an encrypted activation instruction is sent to the target device through the dedicated channel. The activated target device can be initialized by the buyer after the transaction is completed. During initialization, the number of single uses and relevant startup credentials (such as entering an unlocking fingerprint) can be set. In addition, when either the purchase eligibility or the sale eligibility is found to be non-compliant, the order to be verified is intercepted, and a non-compliant party can initiate an appeal to modify a verification result.

More specifically, after the transaction is completed, transaction information is stored in conjunction with ID information of the target device for subsequent tracing. The relevant regulatory platform can obtain the buyer and seller information based on the transaction information or an ID of the target device, thereby achieving data traceability and effective regulation.

Further, after the transaction is completed, the transaction information is stored as the transaction information record for evidence preservation, and the relevant regulatory node can trace and regulate the transaction through the transaction information record stored in the third-party certification node, thus taking into account both regulation and privacy protection.

Specifically, in response to the activation operation of the target device, the transaction information record of the target device is correspondingly generated, and the transaction information record is written into a blockchain evidence preservation system through the third-party certification node.

The blockchain evidence preservation system is a tamper-proof electronic ledger, which is used to permanently record key information of each device activation transaction.

Specifically, when the activation operation of an electronic cigarette device is completed, it means that the current transaction regarding the target device is completed, and the order to be verified transitions to a completed order. In this case, the transaction information record of the completed order is written into the blockchain evidence preservation system. The information involved in the transaction information record includes but is not limited to: a device number, a buyer virtual number, a seller virtual number, buyer identity information corresponding to the buyer virtual number, seller identity information and seller sale qualification information corresponding to the seller virtual number, transaction time and location, etc.

Further, in response to an information traceability instruction sent by a regulatory node, the corresponding buyer identity information and seller identity information are obtained based on the buyer virtual number and the seller virtual number associated with the transaction information record written in the blockchain evidence preservation system.

Specifically, the regulatory node refers to a dedicated server authorized by government regulatory authorities (such as the State Tobacco Monopoly Administration), which has special query privileges; and the information traceability instruction refers to a digital command containing an encrypted electronic seal, similar to an official investigation letter with an official seal affixed.

Specifically, when the regulatory node needs to conduct a traceability investigation on a certain electronic cigarette device transaction, the system initiates a secure information restoration process. This process relies on the blockchain evidence preservation system. The information traceability instruction is sent through an encrypted authorization channel. After receiving the instruction, the system automatically locates a target transaction record in a blockchain and extracts two pieces of core data: the buyer virtual number and the seller virtual number. Next, these virtual numbers are transmitted to a secure decoding system (a data processing center deployed in an independently physically isolated environment). This system restores the original information through a verification mechanism and compares the virtual numbers with an encrypted mapping table stored in a third-party certification platform, so as to obtain the identity information of the buyer and the seller in this transaction.

Further, after the transaction is completed, the buyer can initialize the target device. In this stage, the seller may resell the device to minors for use, in an attempt to circumvent the restrictions on the minors in the purchase process. On such basis, it is further proposed in the present application that after the step of executing an activation operation of the target device, the method further includes:

in response to a device initialization instruction, acquiring biometric data of a current user.

Specifically, the biometric data refers to information that can reflect biometric features of the buyer, including but not limited to facial image information, fingerprint feature information, and vein distribution information. One or a combination of multiple pieces of the feature information can be used as a basis for evaluating whether the buyer has reached the legal age.

Further, the biometric data is input to a pre-trained deep age estimation model, and the biometric data is parsed by the deep age estimation model to output an estimated age value of the current user and a corresponding confidence level parameter.

Specifically, the input biometric data is analyzed and processed using the pre-trained deep age estimation model to obtain an age estimation result of the current user and a confidence level parameter of the estimation result, providing a quantitative reference basis based on deep learning technology for determining the age of the user. Specifically, the acquired biometric data related to the current user is imported into the pre-trained deep age estimation model. The biometric data usually contains various information that can reflect age features of the user. For example, vein distribution of a hand or an arm is obtained by a vein imaging device, fingerprint information is recorded using a fingerprint scanner, and a facial image is captured by a camera.

More specifically, the deep age estimation model is a deep learning algorithm model trained with a large amount of data, which has the capabilities to automatically learn and extract features from the input complex biometric data. After the biometric data is input to the model, the model initiates a series of internal operation mechanisms, and performs layer-by-layer abstraction and feature extraction on the biometric data through a multi-layer neural network structure. For example, when facial image data is processed, an initial network layer may identify basic features such as edges and textures. As the number of layers increases, higher-level features are gradually extracted, such as combined features like shape change patterns of facial organs and wrinkle distribution features.

The model compares and matches the input biometric data of the current user with patterns of biometric features corresponding to different ages learned from the training data. In this process, the model searches for an age range feature that best fits the current data with reference to a feature map presented by a large number of samples with known ages.

Subsequently, after analytic calculation of the model, an estimated age value of the current user is ultimately obtained. This estimated value is obtained based on the comprehensive analysis and determination of the input biometric data by the model. It is a quantified number, representing an age stage that the model deems the current user to be in.

In addition, the model also outputs a corresponding confidence level parameter. The confidence level parameter is a quantitative indicator for measuring the reliability of the age estimation result, and its value range is usually between 0 and 1 (or expressed as a percentage). For example, a confidence level of 0.85 (i.e., 85%) indicates that the model has 85% confidence that the estimated age value is correct. The higher the confidence level is, the greater the certainty of the model about the estimation result is. Conversely, a relatively low confidence level indicates that the model has relatively less confidence in the age estimation result, and there may be greater uncertainty. When referring to this estimated age value, the user needs to carefully judge its reliability in combination with specific situations.

Further, in this embodiment of the present application, it is considered that there may be more misjudgments and false judgments if the evaluation is carried out based solely on one piece of biometric feature information, which may affect the user experience and the actual regulatory effect. Therefore, in this embodiment of the present application, it is also proposed that the biometric data is multi-modal feature information, the multi-modal feature information including at least two pieces of biometric feature information of the current user.

The step of inputting the biometric data to a pre-trained deep age estimation model, and parsing the biometric data by the deep age estimation model to output an estimated age value of the current user and a corresponding confidence level parameter includes:

performing spatiotemporal synchronization calibration on the multi-modal feature information, so that an acquisition time interval between every two pieces of biometric feature information in the multi-modal feature information does not exceed a preset time threshold.

Multi-mode means that the system takes multiple types of biometric feature information into account simultaneously to estimate the age, rather than relying solely on a single type of biometric data. The biometric feature information includes, but is not limited to, a facial image, a fingerprint, a voice feature, vein distribution, etc. Each type of biometric feature information can reflect physiological or behavioral features of the user from different perspectives. By comprehensively analyzing the information, the accuracy and reliability of age estimation can be improved. The system acquires and uses at least two different biometric features for age estimation. For example, it is possible to acquire both the facial image and the fingerprint information of the user, or combine the facial image with the voice feature.

Specifically, the spatiotemporal synchronization calibration includes time synchronization and space synchronization. Specifically, different biometric feature information may be acquired at different time points, that is, time synchronization is required, so the information needs to be aligned in terms of time. For example, if the user provides the facial image and the fingerprint information at different time respectively, the system needs to ensure that the two data points correspond in terms of time for accurate analysis and comparison. In addition, different biometric feature information may be acquired at different time points, so the information needs to be aligned in terms of time, that is, space synchronization is required.

To ensure the timeliness and correlation of the biometric data, the system sets a preset time threshold. This means that when different biometric feature information is acquired, the acquisition time interval between any two types of information cannot exceed the set time limit. If this time threshold is exceeded, the accuracy and reliability of the data may be affected.

Further, the multi-modal feature information subjected to the spatiotemporal synchronization calibration is input to the deep age estimation model, and joint encoding is performed on each piece of biometric feature information in the multi-modal feature information through the deep age estimation model to generate a composite feature vector; and

age prediction and confidence level estimation are executed in parallel by the deep age estimation model based on the composite feature vector to output the estimated age value and the corresponding confidence level parameter.

Specifically, the multi-modal feature information subjected to the spatiotemporal synchronization calibration serves as input data to be input to the deep age estimation model for processing. Subsequently, inside the deep age estimation model, joint encoding is performed on each piece of biometric feature information. The biometric feature information from different sources (such as pixel values of a facial image and feature points of a fingerprint) is combined to form a unified feature representation (i.e., a composite feature vector). The composite feature vector contains key information of all biometric feature information and can better reflect biometric characteristics of the user. After that, the model performs age prediction based on this composite feature vector. Since the model has mastered a mapping relationship from the composite feature vector to the age by learning a large amount of sample data with known ages, the model can estimate the age of the user based on the input composite feature vector.

Simultaneously, the model also performs confidence level estimation. The confidence level parameter is a measure of the reliability of an age prediction result, indicating the certainty or confidence of the model in the prediction result. The higher the confidence level is, the more confident the model is in the prediction result. Conversely, it means that the prediction result may be less reliable or there is greater uncertainty.

Further, if the estimated age value exceeds a preset age threshold and the corresponding confidence level parameter exceeds a preset confidence level threshold, the biometric data is encrypted and stored as a device startup credential.

Specifically, if the estimated age value exceeds the preset age threshold and the corresponding confidence level parameter also exceeds the preset confidence level threshold, it means that the system deems the user to be old enough and the estimation result to be highly reliable. In this case, the system encrypts the biometric data (such as a facial image and fingerprint information) of the user and stores it as a device startup credential, so as to quickly start the target device subsequently with the device startup credential. Encrypted storage can ensure the security of the data and prevent unauthorized access.

In addition, if the estimated age does not exceed the preset age threshold, identity credential information corresponding to the current user is retrieved from the third-party certification node for appeal verification, and when and only when the appeal verification is passed, the biometric data is encrypted and stored as the device startup credential.

Specifically, if the estimated age value does not exceed the preset age threshold, it indicates that the system deems that the user may not meet a certain specific age requirement, or the age estimation result is not reliable enough. In this case, instead of directly storing the biometric data as the device startup credential, the system retrieves the identity credential information corresponding to the current user in the third-party certification node for appeal verification. The appeal verification may include providing additional identity documents, verification code-based verification, or other security verification measures to ensure the authenticity and legality of the identity of the user. In this case, the system encrypts and stores the biometric data of the user as the device startup credential when and only when the appeal verification is passed.

In addition, considering that the buyer may have already undergone a round of determination of the purchase eligibility during transaction, in order to avoid the waste of computing power caused by repetition and to improve the usage experience of the user, in this embodiment of the present application, it is also proposed that before the step of inputting the biometric data to a pre-trained deep age estimation model, the method further includes:

analyzing matching degrees between the biometric data and pre-stored buyer biometric feature templates, where the pre-stored buyer biometric feature templates are constructed based on the buyer identity information; and

when the similarity exceeds a preset similarity threshold, activating the target device, and encrypting and storing the biometric data as the device startup credential.

Specifically, during transaction, the buyer may have already undergone a round of determination of the purchase eligibility. This means that the system already has some biometric feature information (such as a facial image and a fingerprint) of this user and has carried out preliminary identity verification. Based on this, before inputting the biometric data to a pre-trained deep age estimation model, the system first analyzes matching degrees between the currently acquired biometric data and pre-stored buyer biometric feature templates. These pre-stored biometric feature templates are constructed based on the buyer identity information that has been verified in previous transactions.

Based on this, when the similarity between the currently acquired biometric data and the pre-stored buyer biometric feature templates exceeds a preset similarity threshold, the system deems the user to be a repeated user, and this user has already passed the previous purchase eligibility determination. The system directly activates the target device without the need for further evaluation by the deep age estimation model. Meanwhile, the system encrypts and stores the biometric data of the user as a device startup credential for subsequent use.

Further, considering the health aspects of products in design, in order to disrupt the continuity of a smoking process and constantly remind users to pay attention to their own health, in this embodiment of the present application, it is also proposed that a usage limit function can be added in a device initialization stage. Specifically, after the step of encrypting and storing the biometric data as a device startup credential, the method further includes:

in response to a device startup instruction, acquiring at least one type of biometric data to be verified from the current user, and calculating matching degrees between the biometric data to be verified and all the biometric data in the device startup credential; and

if the matching degree between the biometric data to be verified and any biometric data in the device startup credential exceeds a preset matching degree threshold, controlling the target device to enter an unlocked state.

Specifically, when the user needs to start the target device, the biometric data to be verified is acquired by a relevant biometric data acquirer (such as a fingerprint scanner), and a matching degree between an acquired result and the device startup credential that has been determined for the target device is calculated, so as to determine whether they match. If the obtained matching degree result exceeds a preset matching degree threshold, that is, it is confirmed that device unlocking conditions are met, a relevant circuit or other hardware in the device is controlled to be unlocked, so that the user can normally use an atomization function of the target device.

Further, during the unlocked state, the number of atomizations is monitored. If the number of atomizations monitored during the same unlocked state exceeds a preset number of atomizations, the target device is controlled to return to the locked state.

Specifically, the preset number of atomizations can be set during device initialization, and the user can adjust it at any time through a setting button of the target device later. The number of atomizations refers to the number of times the target device atomizes liquid and releases gas. In this embodiment, when the device is in the unlocked state, the system starts to monitor and record the number of atomizations. During the unlocked state of the device, if the monitored number of atomizations exceeds the preset number of atomizations, that is, the use of the device has exceeded a preset range, the system takes control measures to make the target device return from the unlocked state to the locked state. It is worth noting that whenever the target device returns to the locked state, a counter for the number of atomizations automatically resets to zero.

Further, in order to match genuine cartridges and effectively prevent potential safety hazards caused by non-genuine cartridges, a cartridge identification function is proposed in this embodiment of the present application. Specifically, after the step of controlling the target device to enter an unlocked state, the method further includes:

In response to a cartridge disengagement operation, controlling the target device to enter a temporarily locked state.

Specifically, when originally in the locked state, the target device may not enter the temporarily locked state. In this embodiment of the present application, it means that when the target device is in the unlocked state or the usage state, if the cartridge disengagement operation is detected, the relevant atomization function of the target device is temporarily locked. The temporarily locked state is similar to the locked state of the target device, but the temporarily locked state means that the device remains in the temporarily locked state only during cartridge disengagement. Once a cartridge is remounted and correctly identified, the device returns to its previous state.

More specifically, in the above embodiment of the present application, it is proposed that the counter for the number of atomizations is started whenever the target device enters the unlocked state. In order to achieve a reasonable settlement, the temporarily locked state is also proposed and the counter for the number of atomizations is not reset.

Further, when a replacement cartridge is inserted, encrypted identification data embedded in the replacement cartridge is read, where the encrypted identification data includes at least a unique identification code and a dynamic hash value;

the encrypted identification data is sent to an anti-counterfeiting verification node to verify the validity of the replacement cartridge; and

if the unique identification code is valid, the dynamic hash value matches, and it is confirmed that the target device passes the cartridge verification, the target device is controlled to release the temporarily locked state and re-enter the unlocked state;

otherwise, it is confirmed that the target device fails in the cartridge verification, and the temporarily locked state is adjusted to a locked state.

Specifically, when a replacement cartridge is inserted into the target device, the system first reads encrypted identification data embedded in the replacement cartridge. The encrypted identification data is crucial for cartridge identity verification, and contains at least a unique identification code for distinguishing different cartridge individuals, and a dynamic hash value. This value is usually dynamically generated based on certain features or production information of the cartridge to ensure the authenticity and integrity of the cartridge.

Next, the system sends the read encrypted identification data to the anti-counterfeiting verification node for verification. The anti-counterfeiting verification node is a system specifically designed to verify the authenticity of products. It will compare and analyze the received data to ensure the effectiveness and legality of the cartridge.

During verification, if the system confirms that the provided unique identification code is valid, the dynamic hash value also matches an expected value on the platform, and the target device itself passes the cartridge verification (that is, there is correct interaction and communication between the device and the cartridge), the system controls the target device to release the current temporarily locked state. This means that the target device re-enters the unlocked state, and the user can continue to use the device normally.

However, if the verification fails, that is, the unique identification code is invalid, the dynamic hash value does not match, or the target device fails to pass the cartridge verification, the system confirms that the cartridge verification of the target device fails. In this case, in order to ensure the safety and compliance of the device, the system adjusts the temporarily locked state of the target device to a stricter locked state. This means that the device is further restricted or some functions are disabled until the problem is solved or a valid cartridge is inserted and successfully verified.

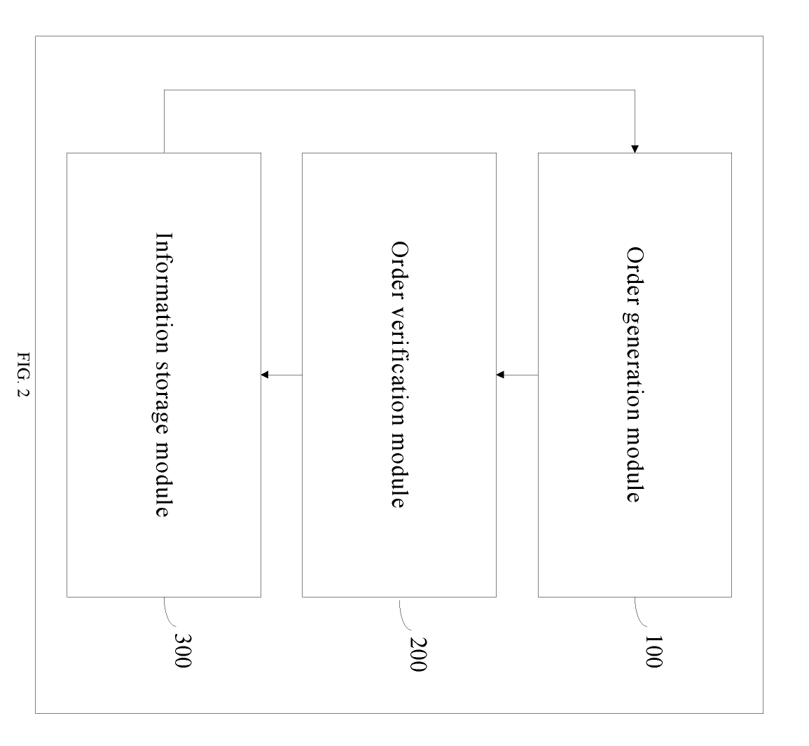

Reference is made to FIG. 2. FIG. 2 is a schematic diagram of a virtual structure of a certification and transaction apparatus for an electronic cigarette provided in the present application. In a second aspect, the present application provides a certification and transaction apparatus for an electronic cigarette, including:

an order generation module 100, configured to create, in response to sending an order initiation instruction to a target device, an order to be verified based on a buyer virtual number through a third-party certification node, where the buyer virtual number is bound to buyer identity information in an irreversible mapping manner and is only stored in the third-party certification node;

an order verification module 200, configured to verify device purchase eligibility of the buyer virtual number in the order to be verified through the third-party certification node, and obtain an associated preset seller virtual number, where the seller virtual number is bound to seller identity information in an irreversible mapping manner and is only stored in the third-party certification node; and

an information storage module 300, configured to generate, in response to successful verification of the purchase eligibility, an activation instruction ciphertext containing a device serial number, execute an activation operation of the target device based on the activation instruction ciphertext, and store a transaction information record containing the buyer virtual number and the seller virtual number.

The certification and transaction apparatus for the electronic cigarette described in this embodiment of the present application can execute the certification and transaction method for the electronic cigarette provided in the above embodiment. The certification and transaction apparatus for the electronic cigarette has the corresponding functional steps and beneficial effects of the certification and transaction method for the electronic cigarette described in the above embodiment. For details, reference is made to the above embodiment of the certification and transaction method for the electronic cigarette, and this embodiment of the present application will not repeat them herein.

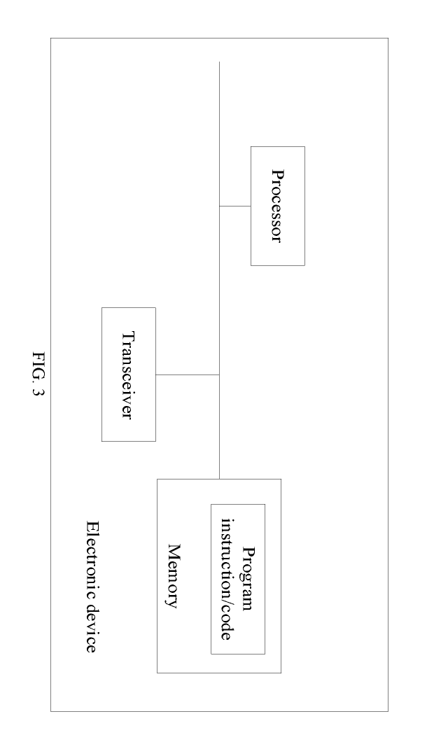

An embodiment of the present application further provides an electronic device. Reference is made to FIG. 3. FIG. 3 is a schematic structural diagram of an electronic device provided in an embodiment of the present application. The electronic device may include a processor and a memory, where the processor and the memory may be connected through a bus or by other means. The processor may be a central processing unit (CPU). The processor may also be other general-purpose processors, digital signal processors (DSPs), application specific integrated circuits (ASICs), field-programmable gate arrays (FPGAs), or other programmable logic devices, discrete gate or transistor logic devices, discrete hardware components and other chips, or a combination of the above various chips. As a non-transitory computer-readable storage medium, the memory can be used to store non-transitory software programs, non-transitory computer-executable programs, and modules, such as program instructions/modules corresponding to the certification and transaction method for the electronic cigarette in the embodiment of the present application. The processor executes various functional applications and data processing of the processor by running the non-transitory software programs, the instructions, and the modules that are stored in the memory, that is, the certification and transaction method for the electronic cigarette in the above method embodiment is implemented.

The memory may include a program storage area and a data storage area, where the program storage area may store an operating system and an application program required for at least one function; and the data storage area may store data created by the processor and so on. In addition, the memory may include a high-speed random access memory, and may also include a non-transitory memory, such as at least one magnetic disk storage device, a flash memory device, or other non-transitory solid-state storage devices. The one or more modules are stored in the memory, and when executed by the processor, they execute the certification and transaction method for the electronic cigarette as in the above method embodiment. The specific details of the above electronic device can be understood corresponding to the relevant descriptions and effects in the above method embodiment, and will not be repeated herein. It can be understood by those skilled in the art that some or all of the processes in the method of the above embodiment may be implemented by a computer program instructing relevant hardware. The program may be stored in a computer-readable storage medium, and when the program is executed, the processes of the above method embodiment may be included. The storage medium may be a read-only memory (ROM), a random access memory (RAM), a flash memory, a hard disk drive (HDD), or a solid-state drive (SSD). The storage medium may also include a combination of the above memories.

A large number of specific details are described in the specification provided herein. However, it can be understood that the embodiments of the present application can be practiced without these specific details. In some examples, well-known methods, structures and technologies are not shown in detail, to avoid blurring the understanding of this specification.

Similarly, it should be understood that, in order to simplify the present disclosure and facilitate the understanding of one or more of the various inventive aspects, in the above description of the exemplary embodiments of the present application, the various features of the present application are sometimes grouped together into a single embodiment, figure, or description thereof. However, the disclosed method should not be construed as reflecting an intention that the claimed application requires more features than those explicitly recited in each claim. More precisely, as reflected in the claims, the inventive aspects lie in fewer than all the features of a single embodiment disclosed above. Therefore, the claims following the detailed description are hereby expressly incorporated into the detailed description, with each claim itself serving as a separate embodiment of the present application.

It should be noted that the above embodiments illustrate rather than limit the present application, and those skilled in the art can design alternative embodiments without departing from the scope of the appended claims.

What is claimed is:

1. A certification and transaction method for an electronic cigarette, comprising:
in response to sending an order initiation instruction to a target device, creating an order to be verified based on a buyer virtual number through a third-party certification node, wherein the buyer virtual number is bound to buyer identity information in an irreversible mapping manner and is only stored in the third-party certification node;
verifying device purchase eligibility of the buyer virtual number in the order to be verified through the third-party certification node, and obtaining an associated preset seller virtual number, wherein the seller virtual number is bound to seller identity information in an irreversible mapping manner and is only stored in the third-party certification node; and
in response to successful verification of the purchase eligibility, generating an activation instruction ciphertext containing a device serial number, executing an activation operation of the target device based on the activation instruction ciphertext, and storing a transaction information record containing the buyer virtual number and the seller virtual number.

2. The certification and transaction method for the electronic cigarette according to claim 1, wherein after the step of obtaining an associated preset seller virtual number, the method further comprises:
verifying whether a validity period of the seller virtual number exceeds a preset time limit threshold by accessing a registration timestamp in the third-party certification node;
in response to the validity period of the seller virtual number exceeding the preset time limit threshold, parsing at least one piece of certification field data in an electronic registration document of a corresponding seller;
comparing the certification field data with a corresponding field recorded by the third-party certification node item by item, and when there is a numerical difference, generating a high-risk identification code; and
triggering a manual review based on the high-risk identification code, and transmitting a manual review request containing a comparison result of discrepancy fields to a regulatory node.

3. The certification and transaction method for the electronic cigarette according to claim 1, wherein the step of storing a transaction information record containing the buyer virtual number and the seller virtual number comprises:
in response to the activation operation of the target device, correspondingly generating the transaction information record of the target device, and writing the transaction information record into a blockchain evidence preservation system through the third-party certification node; and
in response to an information traceability instruction sent by a regulatory node, obtaining the corresponding buyer identity information and seller identity information based on the buyer virtual number and the seller virtual number associated with the transaction information record written in the blockchain evidence preservation system.

4. The certification and transaction method for the electronic cigarette according to claim 1, wherein after the step of executing an activation operation of the target device based on the activation instruction ciphertext, the method further comprises:
in response to a device initialization instruction, acquiring biometric data of a current user;
inputting the biometric data to a pre-trained deep age estimation model, and parsing the biometric data by the deep age estimation model to output an estimated age value of the current user and a corresponding confidence level parameter;
if the estimated age value exceeds a preset age threshold and the corresponding confidence level parameter exceeds a preset confidence level threshold, encrypting and storing the biometric data as a device startup credential; and
if the estimated age value does not exceed the preset age threshold, retrieving identity credential information corresponding to the current user from the third-party certification node for appeal verification, and when and only when the appeal verification is passed, encrypting and storing the biometric data as the device startup credential.

5. The certification and transaction method for the electronic cigarette according to claim 4, wherein the biometric data is multi-modal feature information, the multi-modal feature information comprising at least two pieces of biometric feature information of the current user; and
the step of inputting the biometric data to a pre-trained deep age estimation model, and parsing the biometric data by the deep age estimation model to output an estimated age value of the current user and a corresponding confidence level parameter comprises:
performing spatiotemporal synchronization calibration on the multi-modal feature information, so that an acquisition time interval between every two pieces of biometric feature information in the multi-modal feature information does not exceed a preset time threshold;
inputting the multi-modal feature information subjected to the spatiotemporal synchronization calibration to the deep age estimation model, and performing joint encoding on each piece of biometric feature information in the multi-modal feature information through the deep age estimation model to generate a composite feature vector; and
executing age prediction and confidence level estimation in parallel by the deep age estimation model based on the composite feature vector to output the estimated age value and the corresponding confidence level parameter.

6. The certification and transaction method for the electronic cigarette according to claim 4, wherein before the step of inputting the biometric data to a pre-trained deep age estimation model, the method further comprises:
analyzing matching degrees between the biometric data and pre-stored buyer biometric feature templates, wherein the pre-stored buyer biometric feature templates are constructed based on the buyer identity information; and
when the similarity exceeds a preset similarity threshold, activating the target device, and encrypting and storing the biometric data as the device startup credential.

7. The certification and transaction method for the electronic cigarette according to claim 4, wherein after the step of encrypting and storing the biometric data as a device startup credential, the method further comprises:
in response to a device startup instruction, acquiring at least one type of biometric data to be verified from the current user, and calculating matching degrees between the biometric data to be verified and all the biometric data in the device startup credential;
if the matching degree between the biometric data to be verified and any biometric data in the device startup credential exceeds a preset matching degree threshold, controlling the target device to enter an unlocked state;
in response to a cartridge disengagement operation, controlling the target device to enter a temporarily locked state;
when a replacement cartridge is inserted, reading encrypted identification data embedded in the replacement cartridge, wherein the encrypted identification data comprises at least a unique identification code and a dynamic hash value;
sending the encrypted identification data to an anti-counterfeiting verification node to verify the validity of the replacement cartridge; and
if the unique identification code is valid, the dynamic hash value matches, and it is confirmed that the target device passes the cartridge verification, controlling the target device to release the temporarily locked state and re-enter the unlocked state;
if the unique identification code is invalid, confirming that the target device fails in the cartridge verification, and adjusting the temporarily locked state to a locked state.

8. A certification and transaction apparatus for an electronic cigarette, comprising:
an order generation module, configured to create, in response to sending an order initiation instruction to a target device, an order to be verified based on a buyer virtual number through a third-party certification node, wherein the buyer virtual number is bound to buyer identity information in an irreversible mapping manner and is only stored in the third-party certification node;
an order verification module, configured to verify device purchase eligibility of the buyer virtual number in the order to be verified through the third-party certification node, and obtain an associated preset seller virtual number, wherein the seller virtual number is bound to seller identity information in an irreversible mapping manner and is only stored in the third-party certification node; and
an information storage module, configured to generate, in response to successful verification of the purchase eligibility, an activation instruction ciphertext containing a device serial number, execute an activation operation of the target device based on the activation instruction ciphertext, and store a transaction information record containing the buyer virtual number and the seller virtual number.

9. An electronic device, comprising:
one or more processors;
one or more memories; and
one or more computer programs, wherein the one or more computer programs are stored in the one or more memories and comprise instructions, and when the instructions are executed by the one or more processors, the electronic device is caused to execute the method according to claim 1.

10. A non-transitory computer-readable storage medium, wherein a program or an instruction is stored in the storage medium, and when the program or the instruction is executed, the method according to claim 1 is implemented.
